(19) United States
(12) Patent Application Publication
(10) Pub. No.: US 2007/0226702 A1
(43) Pub. Date: Sep. 27, 2007

(54) Method for operating a microcontroller in a test environment

(76) Inventor: Rolf Segger, Duesseldorf (DE)

Correspondence Address: BEEM PATENT LAW FIRM, 53 W. JACKSON BLVD., SUITE 1352, CHICAGO, IL, 60604-3787, US

(21) Appl. No.: 11/387,066

(22) Filed: Mar. 22, 2006

(51) Int. Cl. G06F 9/44

(52) U.S. Cl. 717/130

(57) ABSTRACT

The invention relates to a method for operating a data processor, especially a single-chip microcontroller, in a test environment (debugger) in which the program code to be tested is modified before, during and/or after the execution of the program to be tested by exchanging individual program instructions, wherein the program instructions are held in a non-volatile and rewritable memory (flash). According to the invention, it is proposed among other things that the temporally or sequentially last command for modifying a program instruction is replaced by a command sequence which causes the data processor to enter the debug mode. The number of rewrite cycles of the non-volatile rewritable memory is hereby minimised in the interactive analysis of the program code to be tested.

The invention relates to a method for operating a processor, especially a single-chip microcontroller in a test environment in which the program code to be tested is modified before, during and/or after execution of the program to be tested by exchanging individual program instructions, wherein the program instructions are held in a non-volatile and rewritable memory.

Various concepts are pursued for testing programs at the machine language level which interrupt the effective execution of the program code to be tested by the processor. Depending on the design of the processor, for example, this is stopped in pre-determinable states of the program or the program is caused by the program code to no longer execute the current program code. In both concepts either a program code or an internal communication interface is activated, which allows interactive communication of a user with the processor. However, concepts are also known in which instructions implemented solely for test purposes are made available to processors, causing the processor to store its complete internal status in a predetermined fashion in the memory and jump to a predeterminable program address in which the program code is stored for interactive manipulation and analysis of the program code to be tested. Despite the numerous concepts for analysing possible defective or initially unknown program codes for a developer, the program code to be analysed is mostly specifically varied for test purposes.

For testing the program this is stored is executable, mostly compiled form in the memory and, according to the concept described above, a test environment is stored at another memory location or is connected externally to the periphery of the system to be tested and analysed (for example, JTAG or BDM interface).

After the program to be tested was stopped, the test environment makes it possible to analyse the processor status, monitor the content of its registers and usually also the contents of the memory.

During the interactive analysis of the program to be tested, in most test and analysis concepts individual instructions of the program to be tested are replaced by the test environment with another instruction, where this instruction can be a special instruction made available by the processor solely for test and analysis purposes but can also be any other instruction used by the test environment to stop the processor. For example, it is feasible that an instruction which does not appear in the processor command set as a replacement instruction can be inserted as a replacement instruction in the program code, wherein the processor can have a device for recognising these replacement instructions and responding thereto in a predetermined manner. The replacement instruction used for test purposes is hereinafter called “stop instruction” in the text.

After the stop instructions have been written into the program code to be tested, the test environment causes the processor to execute the program code of the program to be tested. Thereupon, the program to be tested is executed in the real environment in which the later finished program will also be located and if the processor comes upon the stop instructions described above, the processor reacts in a pre-determined fashion, the actual processor reaction depending on the test and analysis concept. For example, the processor documents its internal status and jumps to a predetermined program address. This is usually an entry address of a locally available code portion of the test environment which the result of the documentation of the processor status makes available to the user of the test environment. In other concepts the processor is stopped and the execution of any program instructions is prevented, where the status of the processor can be determined via an interface externally from the test environment; the processor status can likewise be manipulated from outside.

For continuation of the program to be tested in most test and analysis concepts precisely one instruction counter step is written by the test environment in the program code of the program to be tested after the first instruction replaced by a first stop instruction and a new second stop instruction is inserted after the location of the first stop instruction. If the replaced instructions are jump commands or branchings selected depending on one condition, such as for example a register comparison, the next instruction in relation to the memory address is not replaced by a stop instruction but in jump commands, the instruction to which the jump command points or in conditional branchings the instructions, are replaced by respectively one stop instruction which follows the conditional branching. In unpredictable branchings which in a simple comparison can branch into two branches but in so-called “switch” instructions can also branch into a plurality of branches, every first instruction of each possible branch is replaced by a stop instruction. This procedure is always necessary if the executing processor of the program to be tested does not have single step mode in which the processor executes only one single instruction when individually requested.

At this point most test and analysis concepts are the same. The first instruction originally replaced by a first stop instruction is again replaced by the actual first instruction and this first instruction is executed by the processor. After executing the first instruction, the processor comes upon the second stop instruction which this time again causes the processor to interrupt the program execution depending on the selected test and analysis concept. This second interruption is used by the test environment to again write the first stop instruction at the location of the first instruction and to again replace the second stop instruction by the second original instruction. At this point the test environment causes the processor to continue the program code with the second instruction and this immediately executes the program code of the program to be tested until this again comes across the first stop instruction or another instruction replaced by a stop instruction in the program code to be tested.

This procedure makes it possible to test the program code under conditions very close to reality but the program code of the program to be tested is also varied during the execution as required. Thus, this close-to-reality examination of the program to be tested can only be implemented in an environment in which the program code is present in a volatile and rewritable volatile memory (RAM).

For programs executed from a non-volatile and non-rewritable memory (ROM) this method of continuously exchanging program instructions is not feasible since the non-rewritable memory does not allow any modification of the data in the program code. For this case electronically implemented monitoring functions are available in processors which, for example, monitor the internal program pointer or the data bus and trigger an interruption of the execution of the program code if the program pointer or the data bus have a predetermined value. The program pointer is used by the processor to read the next program instruction from the memory so that monitoring of the program pointer has the result that the processor interrupts the execution of the program before or after execution of a program instruction located at the position in the program memory to which the program counter points.

Whereas when using stop instructions in a rewritable memory the number of stop instructions in the memory is only limited by the size of the memory itself, the number of program break points in the case of an electronically implemented monitoring function is limited by the number of states of the program pointer which can be monitored by the electronics.

Modern high-cost-optimised processors only have a very small number of electronic monitoring functions since these are used exclusively for development purposes and are therefore only used by a very small fraction of users at all. This can result in considerably difficulties as far as obstacles when analysing and testing complex programs.

Highly integrated processors which have storage areas only available on the chip which are divided into a volatile, rewritable memory (RAM) and a non-volatile rewritable memory (flash) where the volatile rewritable memory fraction is selected to be only large enough for storing data and for use as a last-in-first-out memory during execution of programs but is not suitable receiving the complete program code, cannot be investigated sufficiently by the test methods described above because test operation is not possible using stop instructions with a specific exchange of individual program instructions in non-volatile, rewritable memories because it is not possible to selectively modify individual memory elements in these memories and because the available electronically implemented monitoring functions are not usually sufficient for a comprehensive analysis of the program to be tested in high-cost-optimised processors.

It is thus an object of the invention to provide a method for operating a processor in a test environment where it should be achieved that the program code to be tested is at least partly stored as a result of the processor design.

In addition, it is an object of the invention to minimise the time for variation of the program instructions in the program code to be tested to allow fluid operation and analysis.

It is also an object of the invention to rewrite the non-volatile rewritable memory as rarely as possible in the analysis process in order not to prematurely wear out the function of the non-volatile rewritable memory.

These and other objects according to the invention are solved by executing a complete rewriting cycle of the entire data block having the modified program instructions in the non-volatile and rewritable memory by the test environment. Further advantageous embodiments of the invention are obtained from the dependent claims.

As a result of the invention, it is achieved that stopping instructions can also be stored in non-volatile rewritable memories as is also possible in rewritable memories although as a result of the unique property of the non-volatile and rewritable memory it is not possible to selectively vary an individual memory location.

In the method according to the invention for operating a processor in a test environment, the data block containing the instruction to be replaced in the program code is determined for exchanging individual instructions. This data block is completely read out from the processor memory and transferred to the test environment via a communications interface. In this computer system which contains the interactive part of the test program as part of the test environment, the program instruction is replaced in this data block and the complete data block is transferred back to the processor where a writing mode is selected. Optionally, if necessary, the data block in the non-volatile rewritable memory which was read out previously is completely erased with an erase command and rewritten by transferring back the modified program code.

In an alternative embodiment of the method according to the invention, the data block of the non-volatile rewritable memory is transferred by the processor itself into the volatile memory and the processor receives from the test environment at least one replacement command to exchange an instruction by a stop instruction. After exchanging the at least one instruction, the non-volatile rewritable memory is rewritten with the data block from the volatile memory of the processor, optionally whilst previously erasing the data block in the non-volatile rewritable memory, at the appropriate location. As a result of the internal transfer of the data block from the non-volatile rewritable memory into the volatile memory, any transfer via a communications interface is dispensed with, resulting in a considerable gain in time and more realistic execution of the program code when individual instructions are frequently automatically replaced.

In a further embodiment of the invention any readout before replacement of the instruction is completely dispensed with, the content of the non-volatile rewritable memory being logged in the test environment and only the manipulated data block being transferred for writing the non-volatile rewritable memory.

It is common to the different embodiments of the invention that for modification of a single or a plurality of individual instructions respectively one complete data block, which for example can each be 512 Bytes, is written in the non-volatile rewritable memory using one rewrite cycle.

By means of this procedure, for modifying a complete data block at a desired point in each case and completely writing it back, it is also possible to operate processors in a test environment such as is possible for processors in an environment which has sufficient volatile memory to store the program code therein and test according to the prior art.

In an advantageous embodiment of the invention the data block is only transferred back from the test environment and written into the non-volatile rewritable memory of the processor if the command for executing the prepared program is given. It is hereby achieved that optionally a comprehensive number of stop instructions which are to be inserted at selected positions of the program code or are to be inserted by overwriting, are simultaneously written into the non-volatile rewritable memory using only one rewrite cycle. It is hereby possible to avoid unnecessary erase and rewrite functions which increases the lifetime of the data in the processor which has already integrated this storage unit on the chip. This is because the non-volatile rewritable memories have only a limited number of rewrite cycles without the durability of the data in the memory being limited hereby.

The manipulation of the program code is thus carried out independently of the processor by a user in the system to be tested and the manipulated program code is transferred by the user onto the processor with built-in memory in a rewrite cycle directly before the execution command.

As a result of the execution of a single rewrite cycle before an execution cycle of the program to be tested by the processor, a plurality of instructions can be replaced simultaneously. In the known method in the prior art, the replacement of instructions is not achieved simultaneously but each individual instruction is replaced singly in the memory which is not possible in non-volatile rewritable memories (flash).

In a further embodiment of the invention it is provided that instructions replaced by a stop instruction are simulated. The simulation is executed by the test environment. The simulated processor status data are then transferred from the test environment to the processor in the waiting or test state and the processor immediately starts a new execution cycle of the program code to be tested using the new status data.

In contrast to the prior art, in the simulation however it is not the exchanged program command which is written back to the location of the test command again but the replaced command is simulated by the test environment. The simulated data are transferred to the processor in the system to be tested. The processor is then made to jump to the position after the simulated command and continue the execution of the program there using the new status data. By simulating individual program instructions it is unnecessary to exchange stop functions many times and thus comprehensive rewrite cycles are optionally avoided which not only results in an increased lifetime of the non-volatile rewritable memory of the processor but the sometimes tedious rewrite times are eliminated, resulting in more fluid working during the program analysis.

In order to adapt this method to the requirement of a fluid analysis by a developer or user, if the data blocks of a non-volatile rewritable memory are large and respectively one rewrite cycle must be carried out for a larger data block, it is provided in a particular embodiment of the invention to replace an exchange by the activation of a program pointer monitoring for the replacement of an exchange by activation of a program pointer monitoring for the at least one program instruction temporally or sequentially last notified by the test environment for monitoring or probably executed the most frequently by a predictive determination of the program to be tested in a command sequence. In particular, if a program instruction is selected frequently by the developer or user as a program break point, the execution of a complete rewrite cycle means a delay of several seconds which can mean considerable difficulty in the analysis when permanently investigating at this program break point, which prevents fluid working. This problem can be avoided by activating a program pointer monitoring.

In technical jargon a microcontroller with on-chip flash ROM and a small number of hardware breakpoints is thereby easier to debut even when debugging more complex programs because the setting of software breakpoints is initially collated in an internal list of the debugger and all software breakpoints are only written into the flash ROM shortly before a run or single-step command. In order to minimise the number of flash ROM rewrite cycles, it is proposed according to the invention to convert the respectively last breakpoint in relation to the setting of breakpoints from the point of view of the debug unit in the temporal or sequential respect as a hardware breakpoint. This is therefore particularly efficient because during source level stepping and at a go or run command from an instruction which was replaced by a stop instruction, the debugger automatically sets a breakpoint without further action of the user and erases this again a short time later, that is when the source level single step was executed.

The minimisation of the flash ROM write cycles can be even more efficient by predictive determination of the breakpoint which is most frequently started in a debug cycle by the processor in the target system.

By exchanging the step of replacing a program instruction by a stop instruction (software breakpoint) by the step of monitoring this program instruction by a program pointer monitoring (hardware breakpoint), the number of necessarily executed rewrite cycles (flash write cycles) is reduced considerably. This results in more fluid working and analysis, especially in the case of non-volatile rewritable memories with large data blocks and the memory which gradually degenerates as a result of the rewrite cycles is not prematurely worn.

The replacement of the last program breakpoint set by a test environment in relation to the time or in relation to an input sequence in the form of the exchange of a program instruction by a stop instruction (software breakpoint) by a program pointer monitoring (hardware breakpoint) results in a clear reduction in the number of necessary rewrite cycles. In an average analysis method of a developer or user, the strategy is to set a plurality of program breakpoints and a program breakpoint is set at a position selected by the developer or user and occurring last in the logic sequence postulated by the developer or user, at which the results of an analysis cycle (debug cycle) are evaluated by the developer or user. A suspicious modification of the program status is frequently expected by the developer or user at this point. Consequently, this program breakpoint is started so frequently and in an interactive fashion such that this last point selected by the developer or user is frequently the most frequently started point in the analysis cycle. Consequently the use of the program pointer monitoring function for precisely this program breakpoint means a considerable reduction in the number of necessary rewrite cycles, where the desirable side effect is achieved that precisely at this point where the stress of the analysing user can possibly be high, the restarting of the program execution or the implementation of a single step is carried out particularly quickly and without any delay due to the rewrite cycle. Depending on the translation step of the program code, the last program breakpoint set by a developer or user is not necessarily identical to the last program breakpoint set by the test environment and its auxiliary module. If a program breakpoint is set in the test environment in a non-translated program source code, this one program breakpoint in branching commands in the translated program code at machine language level can be translated by the test environment or modules thereof into more than one program breakpoint because the branching command at machine language level is no longer subdivisible and thus the command which actually follows the branching command in the program run can appear at a plurality of points. All these possible branching points are confirmed with a stop instruction by a debug unit which among other things sets individual program breakpoints for a test environment at the positions in the program code at machine language level.

As a result of the predictive determination of the program instruction probably executed the most frequently in a command sequence of the program to be tested, it is achieved that the non-volatile rewritable memory (flash) only needs to be rewritten infrequently since a program pointer monitoring requires no modification of program instructions in the program code but the monitoring function in the system to be tested (on-chip debug unit) can be activated rapidly and simply for monitoring the program point (program counter) by writing a register.

Various methods can be used to execute a predictive determination of the program instruction. Firstly, it is possible to carry out statistics of the program instructions started in an analysis cycle by the processor of the system to be tested (target system) and determine the program instructions as the most frequent program instructions which were started most frequently in past analyses. In this method the prediction, that is the prediction of the next program breakpoint is simply extrapolated from the past. However, it is also feasible to determine the next probable program breakpoint using heuristic rules. This is best illustrated by an example for a branch instruction. Branching as a result of comparing a memory value, register status or other program status data with a specific value will generally be the exception and more frequently the value forming the basis of the branching will not be the same as that of a comparative value. This is especially the case in counting or waiting loops. For the analysis (debugging) of a branching (branch instruction) the test environment (debugger) and its auxiliary modules must select more than one program breakpoint by exchanging a program instruction by a stop instruction (software breakpoint) and/or by a program pointer monitoring (hardware breakpoint). If, for example, only an electronically implemented program pointer monitoring function is available, as a result of the heuristic rules in the test environment the branch will be monitored by a program pointer monitoring as a program breakpoint which is probably started more frequently in the program as a result of the heuristic rules put forward above.

Heuristic rules, especially in conjunction with typical program instruction blocks generated by a compiler, are known from the technology of pipelining of program instructions in highly optimised processors. These rules can also be used for minimising rewrite cycles of the non-volatile rewritable memory.

In an advantageous embodiment of the invention the method according to the invention is implemented in an electronic test unit (debug unit) which has two communication interfaces. For this purpose the electronic test unit is connected to a generic computer (PC) which has a test environment (debugger), for example, via a USB cable. Using the other communication interface the electronic unit is connected to the target system, for example via a JTAG or BDM interface. The debug unit receives a command for setting a program breakpoint from a generic test environment. This command is acknowledged by the debug unit but is not initially transferred by the electronic unit into the target system. Only when all program breakpoints have been notified and this is the case if a program execution command (run) or a single-step command (single-step instruction) has been issued to the electronic unit, does the electronic unit initiate a process which causes the target system to set all program breakpoints by simultaneously replacing single or a plurality of program instructions by stop instructions. This is achieved by rewriting a data block containing the affected program instructions, the at least one program breakpoint being contained in the dataset for rewriting.

The electronic unit can carry out statistics used for prediction itself or execute the heuristic rules for predictive determination of the most frequently accessed commands itself but it is also possible for the statistics or the heuristic rules for predictive determination to be carried out in a program section in the generic computer with test environment (debugger).

The electronic unit can merely take over communication tasks and the complete logic for the determination and for the exchange of program instructions can be implemented in a software section, for example a so-called DLL (dynamic link library or dynamically linked library) but it is also possible for the electronic unit to fulfil all the tasks itself and the test environment (debugger) takes over the communication and the exchange of program instructions.

The method according to the invention is explained in detail with reference to the following figures.

In the figures:

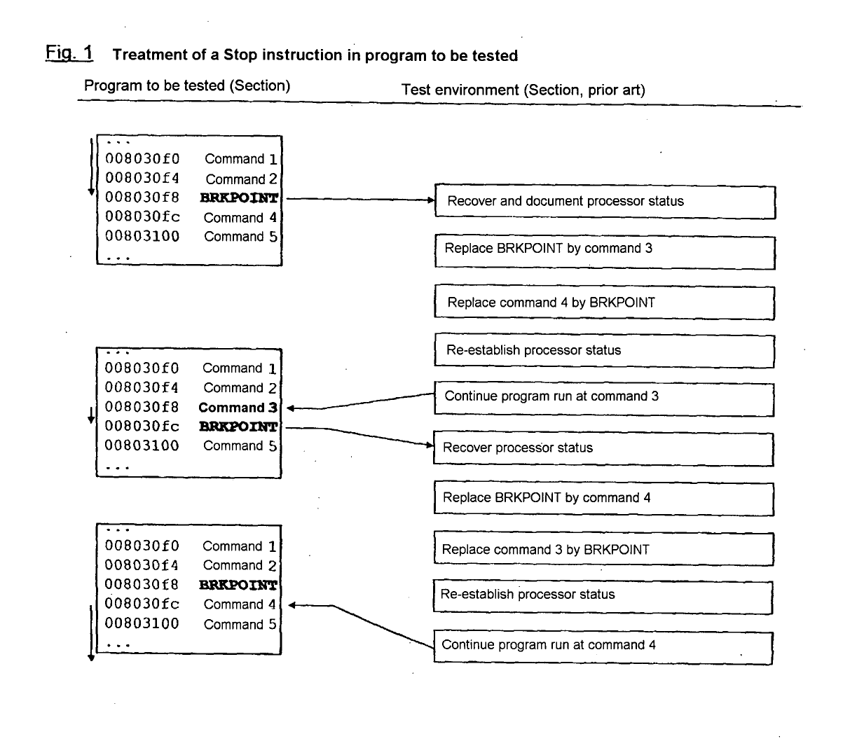

FIG. 1 is a section of a schematic flow diagram for the treatment of stop instructions in the program to be tested according to the prior art,

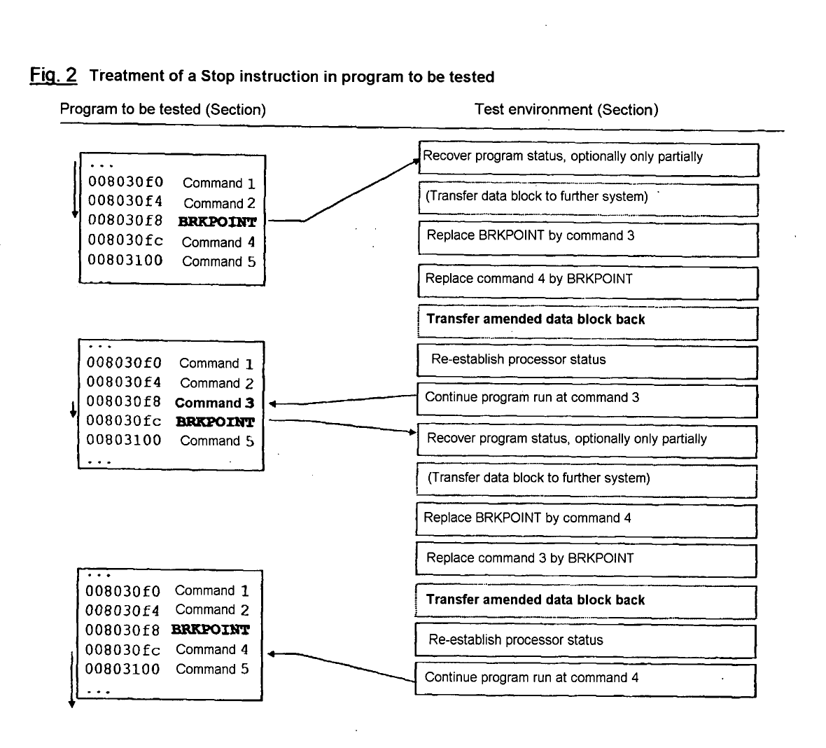

FIG. 2 is a section of a schematic flow diagram for the treatment of stop instructions in the program to be tested according to the invention,

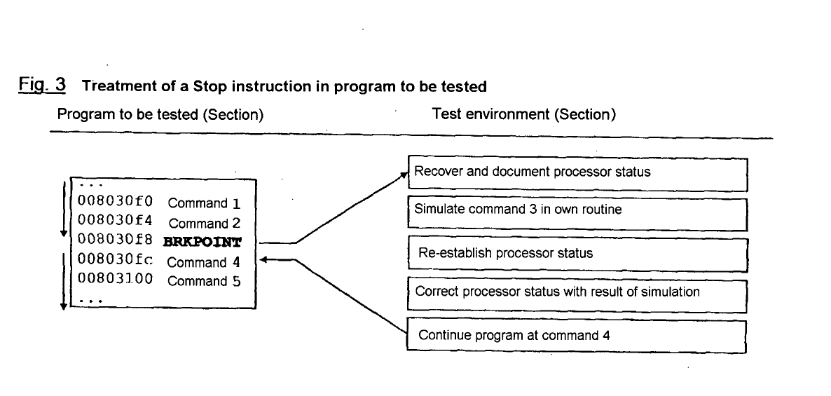

FIG. 3 is a further section of a schematic flow diagram for the treatment of stop instructions in the program to be tested according to the invention,

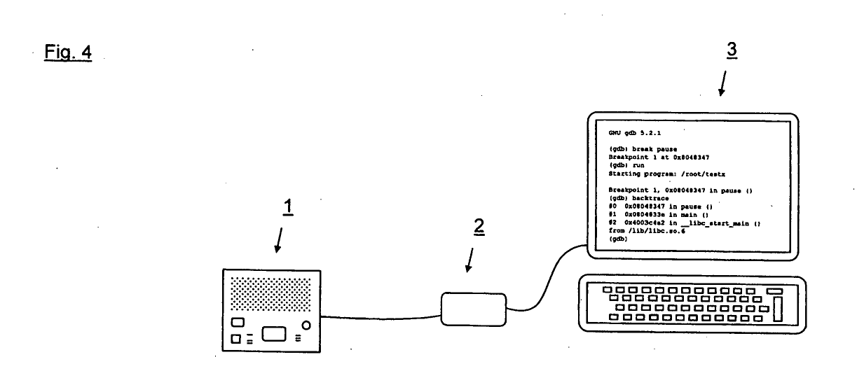

FIG. 4 is a typical structure of a system to be tested comprising an electronic unit for executing the method according to the invention and a test environment on a computer,

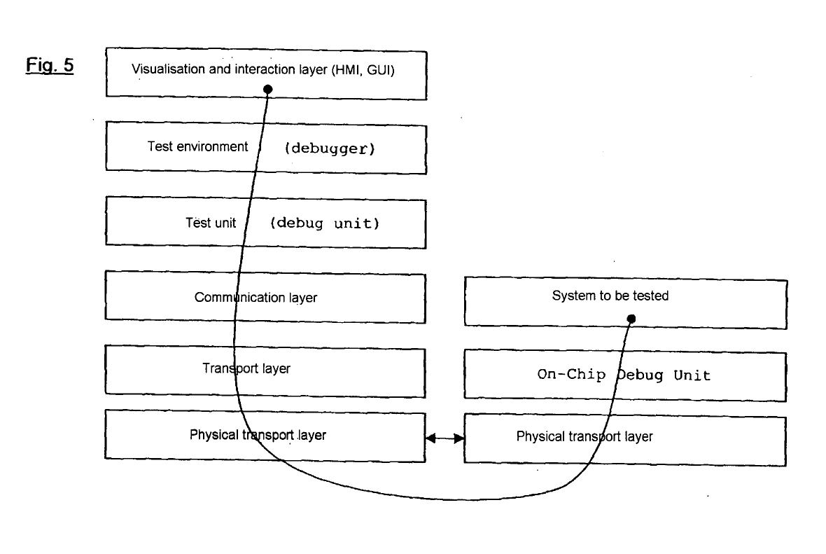

FIG. 5 is a layer model of various interacting program sections for the example of a method according to the invention implemented in the computer of the test environment,

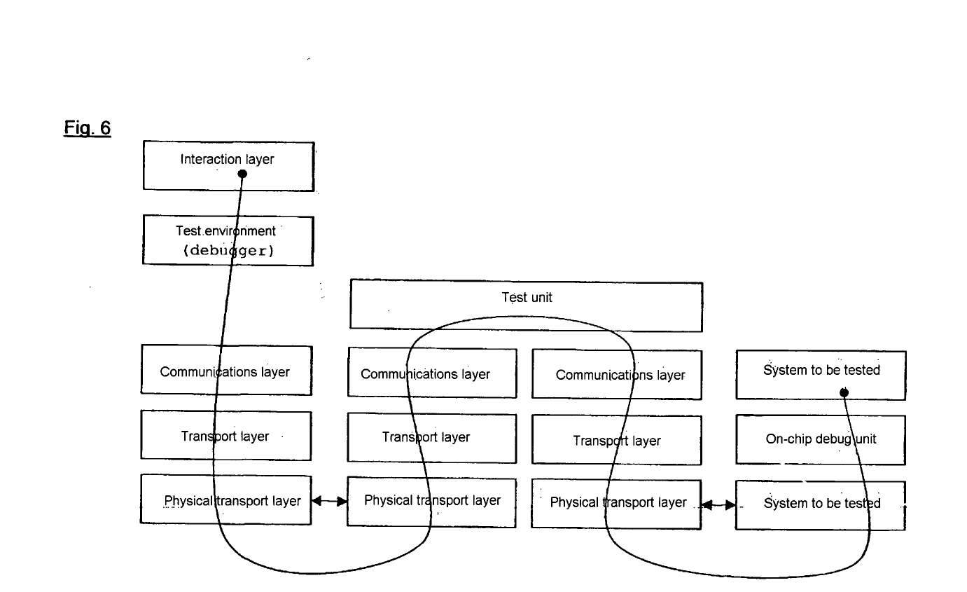

FIG. 6 is a layer model of various interacting program sections for the example of a method according to the invention implemented in an electronic unit,

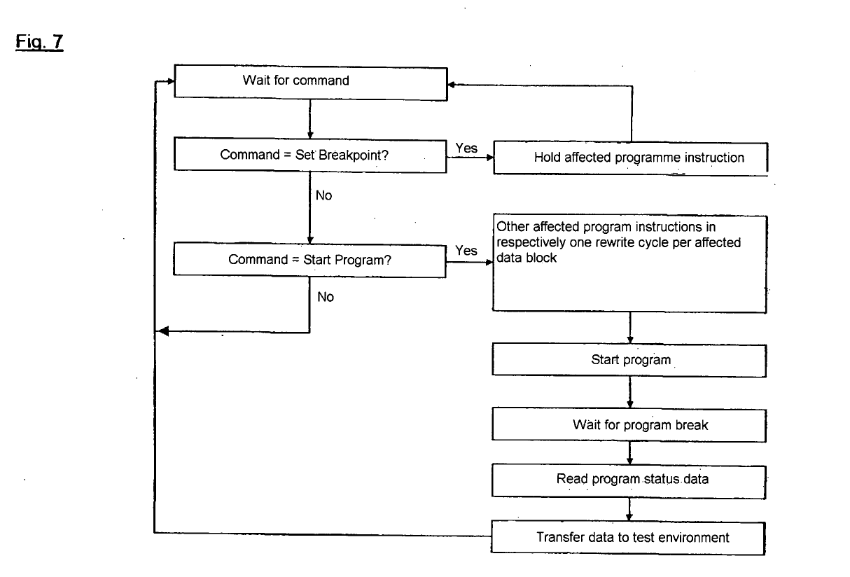

FIG. 7 is a section of a simplified logic flow diagram and

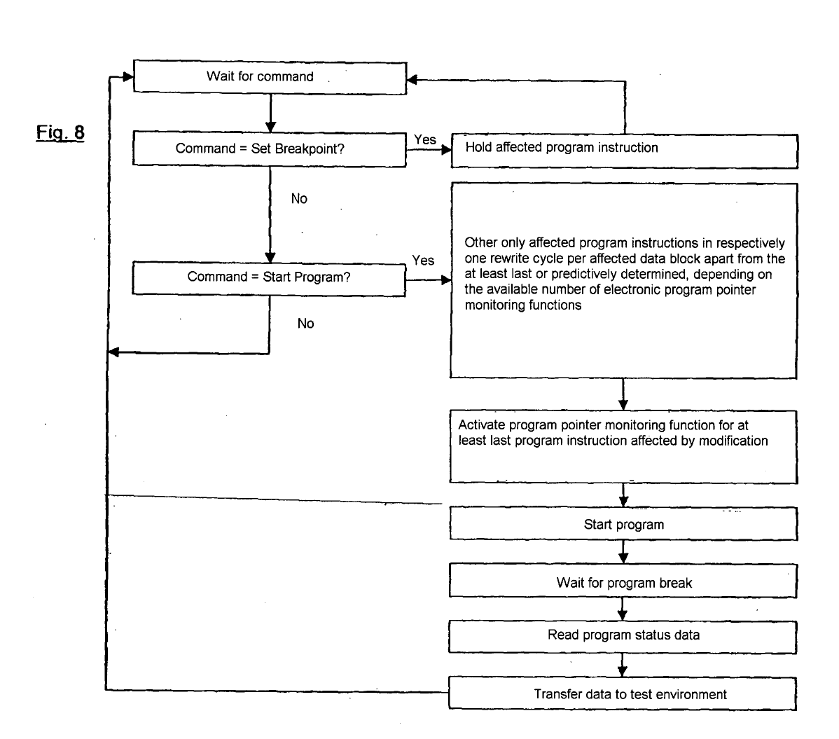

FIG. 8 is a section of a further simplified logic flow diagram.

In FIG. 1 the left-hand column of the table shows three identical sections of the program to be tested which have a different program instruction sequence as a result of modifying the instructions. The right-hand column of the table reproduces a section of the logic instruction sequences of a test environment. FIG. 1 shows a section of a method for testing such as is carried out in the prior art in systems which provide a volatile memory (RAM) if the processor of the program to be tested does not have a single-step mode.

The processor initially executes the program to be tested as shown schematically in the uppermost program section in the left column until it comes across a stop instruction, here arbitrarily designated as BRKPOINT. The stop instruction causes the processor, in different ways depending on the design, for example simply to stop and wait for interactive commands at a special communication interface or for example, to store the entire processor status and optionally interactively document this. In the test environment this interruption of the processor in the system to be tested is followed by logic instructions which replace the content of the memory location, here memory location #008030f8h by a command 3 which was originally located there. This command 3 is stored in the test environment in a table or a database. In addition, command 4 following command 3 is replaced by a stop instruction, BRKPOINT in this case.

Thereafter the processor status is re-established by the test environment and the test environment causes the processor to continue the program to be tested, which is now in the state according to the centre of the left-hand column, at memory location #008030f8h where command 3 is now saved. Command 3 is executed and the processor now comes across the memory location #08030fch where command 4 was located previously and has now been replaced by a stop instruction. At this point however, the processor is moved into a hold state and the status is optionally saved, the stop instruction BRKPOINT at memory location #008030fch is again replaced by command 4 and then command 3 is again replaced by the stop instruction BRKPOINT. The processor status is then re-established and the test program causes the processor to continue the program run at memory location #008030fch where command 4 is now located again.

This method is suitable for processors operating in an environment where volatile memories are available for receiving the program code if no single-step mode is available. The method described is thus applied provided that the command 3 described in this example is not a jump command or conditional branching command. In this case, the next commands in relation to the program pointer would not be replaced by stop instructions but the logically following commands, for example, the commands to which a jump command points or the commands located at the beginning of a program branch which can be tracked by the conditional branching command.

However, this method is not suitable for testing program which are exclusively stored in a non-volatile rewritable memory (flash).

FIG. 2 thus show a similar sequence of different states of a program to be tested and logic program instructions of a test environment where these logic instructions can also be used to test a program which is exclusively stored in a non-volatile rewritable memory.

The uppermost line of the left-hand column in FIG. 2 shows the state of section of the program to be tested which is carried out according to the method according to the invention by writing a complete block in which some instructions have already been replaced by stop instructions. The program to be tested is initially executed until the processor comes across the memory location #008030f8h where there is a stop instruction, in this case arbitrarily designated as BRKPOINT. This stop instruction for example cause the processor either to jump to a locally available part of the test environment where it first recovers and documents the processor status or, for example it causes it to stop and wait for interactive commands at the communication interface. According to one embodiment of the method according to the invention the content of the data block of the non-volatile rewritable memory containing this instruction is transferred to another system via a communication interface. In this other system the stop instruction BRKPOINT in the data block is replaced by a command 3 from an internally stored table. The command 4 following command 3 is then replaced by a stop instruction, here called BRKPOINT, and the entire data block is optionally transferred back whilst erasing the data block in the non-volatile rewritable memory of the processor.

The processor status is then re-established and the test environment causes the processor to continue the program to be tested at the memory location #008030f8h where command 3 is now located and the processor again comes upon the stop instruction directly following command 3. As described above, this new stop instruction causes the processor, for example, to recover the processor status or to stop, for example, and wait for interactive commands at the communication interface and to transfer the entire content of the data block which contains the stop instruction instead of command 4, to another system. However, the transfer from the processor into the test environment is not necessary if the test environment logs the content of the non-volatile rewritable memory and accordingly only notifies the content of the data block to be newly written to the processor or in another alternative case, causes the processor to transfer the relevant data block internally from the non-volatile rewritable memory into the volatile memory, undertake individual modifications there and write the entire data block again whilst executing a complete rewrite cycle in the non-volatile rewritable memory. In the case where this is completely read out, in the other system this stop instruction BRKPOINT is now reset by command 4 from a table and command 3 inside this data block is replaced by a stop instruction BRKPOINT. This data block is then transferred back optionally whilst erasing the data block in the non-volatile rewritable memory and the test environment causes the processor to continue the program to be tested at the memory location #008030fch where command 4 is located.

FIG. 3 shows another method for testing programs. As an alternative to transferring an entire data block into another memory system, manipulating the data there by the test environment and then transferring back, it is provided that the processor is caused by the stop instruction, here arbitrarily called BRKPOINT, to stop and have the instruction actually located there simulated by another system where the processor receives the results of the simulated modification of the processor status in the system to be tested, takes over these simulated modifications and takes up the execution of the program again at the next instruction using the new processor status data.

The simulation of individual commands which have been overwritten by a stop instruction on the one hand makes it possible to dispense with time-consuming rewrite cycles which impair the lifetime of data in the processor. A considerable time advantage is obtained by this type of testing since the rewrite cycle can take up to 2 seconds depending on the design of the non-volatile rewritable memory.

FIG. 4 shows a typical structure situation when testing a microcontroller on a developer system 1 which is tested using an electronic unit 2 (debug unit) and a computer 3 with test environment. The test environment in computer 3 gives remote analysis commands (remote debug instructions) to the electronic unit 2, where the electronic unit executes the method according to the invention and it remains unknown to the test environment how the program breakpoints have actually been converted in the developer system. The electronic unit 2 then passes the commands for replacement of the program instructions to the developer system 1 precisely when the command for program execution (run) or for single-step execution (single step) is given at the computer. The program instructions affected by the program break are then exchanged in a rewrite cycle per data block and activation of the program pointer monitoring is optionally carried out.

FIG. 5 shows a layer model showing the connection of the individual program modules involved in the method according to the invention, segments, DLL or similar parts of a test environment which can be delimited from one another. An uppermost visualisation and interaction layer communicates with a test environment (debugger) which delivers analysis commands and the setting and replacing of program breakpoints to another layer, the test unit (debug unit) which in this case is implemented only as a program section on the computer having the test environment. This test unit passes commands to a communication layer which converts the commands from the test unit into a communication protocol which is understood by the system to be tested (in FIG. 4 the developer system). The transport layer is a program section in which wrapping of the communication protocol takes place so that this can be sent to the system to be tested over the physical transport layer (for example, serial, parallel, bus or wireless). There the electronic communication is taken up again and evaluated by the on-chip debug unit which, for example, has the electronically implemented program pointer monitoring function or the on-chip debug unit is activated simply by specifying parameters such as a value for the program pointer to be monitored. The indicated path reproduces the path of a command predefined by a user through the layers and shows how the test to be tested is embedded in the test environment.

FIG. 6 shows a layer model comparable to FIG. 5 where, however, the test unit is not implemented as DLL or comparable program module as a layer in the computer which exhibits the test environment but is present as an intrinsic system in an electronic unit. The commands run through the layers beginning at the interaction layer on the computer with the test environment and are sent from there through the communication and transport layers until they finally arrive in the test unit at the system to be tested by implementing and applying the method according to the invention. Data are sent back from the system to be tested to the interaction layer correspondingly and in reverse order.

FIG. 7 shows a section of a simplified logic flow diagram which corresponds to the procedure from claim 1. For this the system first waits for a command from outside and when a command arrives, branching takes place at various points depending on the command. If the command was a command for setting a program breakpoint, this program breakpoint is initially held internally but not immediately passed on to the system to be tested. If the command is a program execution command or a command for executing a single step, the held program instructions are modified in respectively one rewrite cycle per affected data block. Only then is the command for starting the program or for implementing a single step passed on to the system to be tested and waits for a program break. Program status data are then read out from the system to be tested and transmitted to the test environment. After transmission has taken place, the system again waits for an external command.

FIG. 8 shows a section of a logic flow diagram comparable to FIG. 7 but where at least the last command for setting a program break point in time reference or with reference to a sequence is not carried out by exchanging the affected program instruction by a stop instruction but by activating a program pointer monitoring. The remaining parts of the logic sequence plan correspond to the sequences in FIG. 7.

Explanation of terms used herein

| | |
|---|---|
| Test environment including auxiliary | Debugger |
| modules such as debug unit | |
| Program section as auxiliary module of | Debug unit |
| a test environment or also electronic | |
| unit which adapts the special properties | |
| of a system to be tested to the program | |
| interface of the test environment | |
| Testing, analysing | Debugging |
| Testing and analysing a program in a | Remote debugging |
| system to be tested using another | |
| system so that in the system to be tested | |
| there are almost no modifications as far | |
| as no modifications at all compared | |
| with a program run under real | |
| conditions | |
| Program run between two program | Debug cycle |
| breaks at the same program break | |
| instruction | |
| Translate into machine instructions | Assemble or compile |
| Program for automatic translation of | Assembler, compiler |
| programming languages into a | |
| sequence of machine instructions | |
| Machine language | Assembly code |
| Volatile rewritable memory | RAM |
| Non-volatile, non-rewritable memory | ROM |
| Non-volatile rewritable memory | Flash ROM |
| Program break point | Breakpoint |
| Program break point triggered by an | Software breakpoint |
| instruction or by a bit pattern on the | |
| data bus | |
| Program break point triggered by | Hardware breakpoint |
| monitoring the program pointers of a | |
| processor | |
| Rewrite cycle | Rewrite cycle |
| Program execution | Run, go |
| Execution of a single program | Single step |
| instruction | |
| Cause the system to carry out a | Stepping |
| program in steps | |
| Be located in a program at a point | Source level |
| which corresponds to the beginning of a | |
| command in a non-translated program | |
| language | |
| Modification of data in a locally | Modification offline |
| available copy without being connected | |
| to system in which the original data is | |
| present | |
| Data block of a memory consisting of | Sector |
| more than a single storage unit | |
| Last-in-first-out memory | Stack |
| Instruction which results in a multiple | Switch instruction |
| branching | |
| Program unit or electronic unit with | Debug unit |
| program section which takes over the | |
| actual execution of the setting and | |
| replacing of program break instructions | |
| from a further program unit of a test | |
| environment | |
| Own names or trademark names of | RS232, RS422, RS485, |
| serial communication protocols | TCP/IP, UDP and |
| | FireWire |
| Own names or trademark names of bus | ISA, MCA, PCI, dPCI, |
| communication protocols | PCMCIA, CompactFlash, |
| | USB, Ethernet, |
| | fieldbus, HPIB and |
| | GPIB |
| Own names or trademark names of | IEEE 802.11b, IEEE |
| wireless radio communication protocols | 803.11g and BlueTooth |
| Own name or trademark name of | Centronics |
| parallel communication protocols | |
| Own names or trademark names of a | JTAG and BDM |
| special communication interface and | |
| corresponding communication protocol | |
| for remote analysis of systems | |
| Located on the same substrate of | On-chip |
| another semiconductor or another | |
| semiconductor unit | |
| Branching instruction | Branch instruction |
| Personal computer | PC |
| Program module which is dynamically | dll, also |
| loaded in the memory of a system for | dynamically linked |
| execution | library |
| Instruction, command | Instruction |
| Clad or pack data in other data | Wrap |
| Technology for offset parallel | |
| processing of program instructions by a | |
| processor | |

1. A method of operating a data processor, in particular a single-chip microcontroller, in a test environment (debugger) in which the program code to be tested is modified before, during and/or after the execution of the program to be tested by exchanging individual program instructions, wherein the program instructions are held in a non-volatile and rewritable memory (flash), the method comprising the execution of a complete rewrite cycle in respect of the complete data block (flash sector) containing the modified program instructions in the non-volatile and rewritable memory (flash) by the test environment (debugger).

2. The method of claim 1, comprising the simultaneous exchange of a plurality of program instructions contained in a data block (flash sector) of the non-volatile and rewritable memory (flash) in a single rewrite cycle.

3. The method of claim 1, comprising a simulation of the exchanged program instructions.

4. The method of claim 1, comprising:
setting a hardware breakpoint in respect of a program instruction intended for exchange, instead of exchanging that program instruction.

5. The method of claim 4, comprising:
setting a hardware breakpoint in respect of a program instruction likely to be selected for exchange, in particular in respect of a program instruction selected for exchange in a previous test cycle, or in respect of a program instruction likely to be executed the most frequently.

6. An electronic test unit for analysing program code, comprising at least two communication interfaces, wherein a first communication interface is connected with a system to be tested in which the program code to be analysed is executed, and a second communication interface is connected with a system in which at least part of a test environment is implemented, wherein the electronic test unit comprises a processor arranged to receive commands from the test environment to modify program instructions in the system to be tested and to forward the commands to the system to be tested, and to receive program status data from the system to be tested and to forward the program status data to the test environment, wherein, in response to a modification command from the test environment to modify at least one selected program instruction in the system to be tested, the processor causes the system to be tested to rewrite the entire data block which contains the selected program instruction, in a complete rewrite cycle, thereby to modify the selected program instruction.

7. The electronic test unit of claim 6, wherein the processor of the electronic test unit is arranged to store the modification command in a list, table or a database, to execute the modification command responsive to receipt of an execution command, and to perform a rewrite cycle for each affected data block not linked to further affected data blocks.

8. The electronic test unit of claim 6, wherein the processor is arranged to cause the system to be tested not to modify the selected program instruction, and to set a hardware breakpoint in respect of the selected program instruction instead.

9. The electronic test unit of claim 6, wherein the first communication interface is a standard computer interface, wherein the communication protocol and the corresponding electronics support one or more protocols selected from a group of serial protocols such as RS232, RS422, RS 485, TCP/IP, UDP, FireWire, bus such as ISA, MCA, PCI, cPCI, PCMCIA, CompactFlash, USB, Ethernet, Fieldbus, HPIB, GPIB, wireless protocols such as IEEE 802.11b, IEEE 802.11g, bluetooth, and parallel protocols such as Centronics, and wherein the second communication interface supports standard analysis communication protocols such as JTAG or BDM.

10. A data processing system arranged to perform the method of claim 1.

11. A computer program including machine-readable instructions which, when executed by a data processing system, cause the data processing system to perform the method of claim 1.

12. An article comprising a storage medium storing machine-readable instructions forming the computer program of claim 11.
